(19) United States
(12) Patent Application Publication
(10) Pub. No.: US 2017/0292692 A1
(43) Pub. Date: Oct. 12, 2017

(54) LED Lamp Bulb

(71) Applicant: Tse Min Chen, Hsinchu (TW)

(72) Inventor: Tse Min Chen, Hsinchu (TW)

(21) Appl. No.: 15/096,380

(22) Filed: Apr. 12, 2016

(51) Int. Cl. F21V 31/00; F21K 9/237; F21V 23/00; F21K 9/232

(52) U.S. Cl. CPC F21V 31/00; F21K 9/232; F21K 9/237; F21V 23/009; F21Y 2115/10

(57) ABSTRACT

A LED lamp bulb includes an envelope having a tubular neck, a LED driver module including a cladding layer-wrapped circuit board press-fitted into the tubular neck of the envelope in a watertight manner, a LED circuit assembly supported on the circuit board-wrapped circuit board and suspending in the envelope and positive and negative lead wires respectively connected to the cladding layer-wrapped circuit board and disposed outside the envelope, and a lamp head bonded to the outer peripheral wall of the tubular neck of the envelope with the center contact thereof electrically connected with the positive lead wire of the LED driver module and the ring contact thereof electrically connected with the negative lead wire of the LED driver module.

### BACKGROUND OF THE INVENTION

### 1. Field of the Invention

The present invention relates to electric lamps and more particularly, to a LED lamp bulb, which provides a waterproof sealing effect, and allows bonding of the positive and negative lead wires of the LED driver module to the ring contact and center contact of the lamp head automatically using a conventional incandescent lamp bulb lead wire bonding technique, saving much labor and time, increasing productivity and significantly reducing the manufacturing cost.

### 2. Description of the Related Art

A conventional incandescent lamp bulb generally comprises a glass or quartz bulb filled with inert gas or evacuated, a wire filament suspended in the glass or quartz bulb, a lamp head fixedly connected with the glass or quartz bulb, and positive and negative conducting wires respectively and electrically connected between the two opposite ends of the wire filament and the ring contact and center contact of the lamp head. The installation of the lamp head in the glass or quartz bulb and the bonding between the positive and negative conducting wires and the ring contact and center contact of the lamp head can be achieved using an automatic bonding and assembly equipment.

Further, various LED lamp bulbs have been created to replace conventional incandescent lamp bulbs. A LED lamp bulb generally comprises an envelope, a lamp head, a LED driver module and a LED circuit assembly. This design of LED lamp bulb is still not satisfactory in function due to the drawbacks as follows:
1. The LED driver module and the envelope cannot be set in position steadily, and therefore, the bonding of the positive and negative lead wires cannot be achieved using a conventional automatic incandescent lamp bulb bonding and assembly equipment. Because the bonding of the positive and negative lead wires relies upon labor, the fabrication of the LED lamp bulb requires much labor and time, relatively increasing the manufacturing cost. If the negative lead wire is clamped between the envelope and the lamp head without bonding, there is a danger of disconnection of the lead wire. In order to facilitate implementation of an automatic bonding and assembly process, a complicated and expensive modification design will be necessary, however, due to high cost, this measure does not have a significant industrial value.
2. Water can leak through gaps between the LED driver module and the envelope to wet the internal circuit components of the LED lamp bulb, resulting in failure or short circuit and lowering the safety level.

### SUMMARY OF THE INVENTION

The present invention has been accomplished under the circumstances in view. It is therefore the main object of the present invention to provide a LED lamp bulb, which comprises an envelope having a tubular neck, a LED driver module including a cladding layer-wrapped circuit board press-fitted into the tubular neck of the envelope in a watertight manner, a LED circuit assembly supported on the circuit board-wrapped circuit board and suspending in the envelope and positive and negative lead wires respectively connected to the cladding layer-wrapped circuit board and disposed outside the envelope, and a lamp head bonded to the outer peripheral wall of the tubular neck of the envelope with the center contact thereof electrically connected with the positive lead wire of the LED driver module and the ring contact thereof electrically connected with the negative lead wire of the LED driver module. Because the LED driver module is fixedly connected to the envelope in a watertight manner by press-fitting the cladding layer-wrapped circuit board into the inner peripheral wall of the tubular neck of the envelope in a watertight manner, the LED lamp bulb provides a waterproof sealing effect.

Further, because the LED driver module is fixedly connected to the envelope in a watertight manner by press-fitting the cladding layer-wrapped circuit board into the inner peripheral wall of the tubular neck of the envelope tightly, the positive and negative lead wires of the LED driver module can be bonded to the ring contact and center contact of the lamp head and checked automatically using a conventional incandescent lamp bulb lead wire bonding technique.

Further, assembling the LED lamp bulb can be done using an automatic assembly system, saving much labor and time, increasing productivity and significantly reducing the manufacturing cost.

### BRIEF DESCRIPTION OF THE DRAWING

FIG. 1 is a plain view of a LED driver module for LED lamp bulb in accordance with the present invention.

FIG. 2 is a plain view illustrating the LED driver module covered with a cladding layer-wrapped circuit board in accordance with the present invention.

FIG. 3 is a schematic sectional view of the present invention, illustrating the LED driver module covered with a cladding layer-wrapped circuit board and installed in the envelope.

FIG. 4 is an exploded view of the LED lamp bulb in accordance with the present invention.

FIG. 5 is a sectional assembly view of the LED lamp bulb in accordance with the present invention.

### DETAILED DESCRIPTION OF THE INVENTION

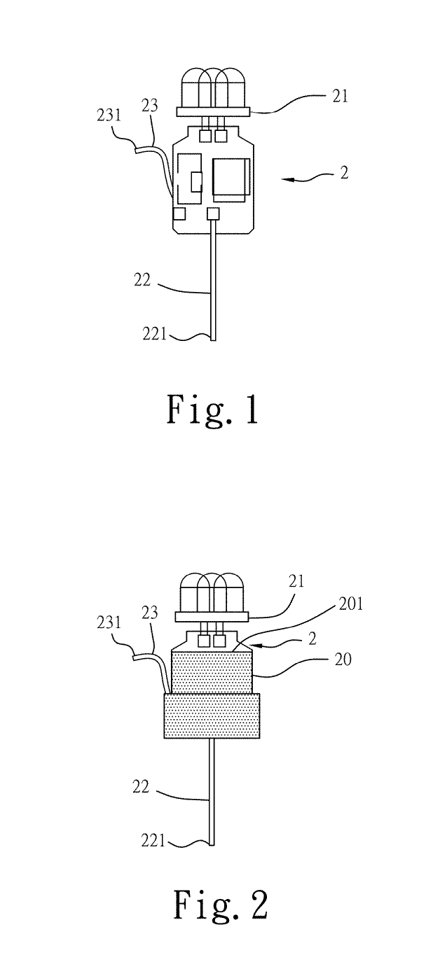

Referring to FIGS. 1-5, a LED lamp bulb in accordance with the present invention is shown. The LED lamp bulb comprises:

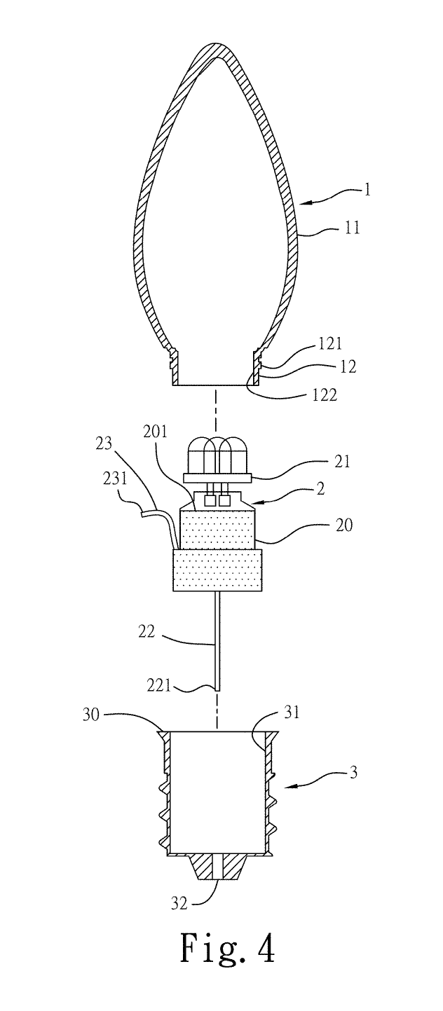

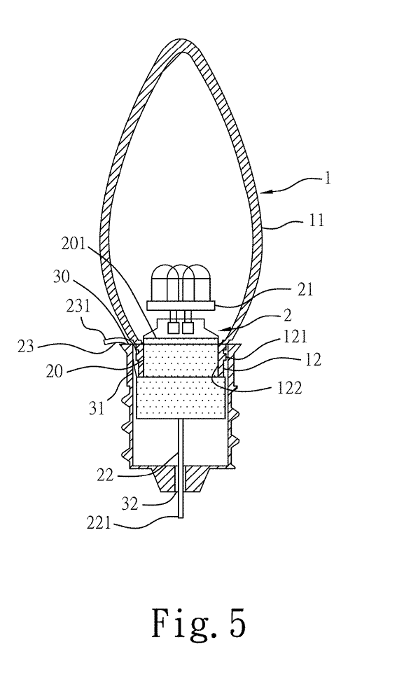

an envelope 1 (see FIG. 4 and FIG. 5), comprising a hollow envelope body 11 and a tubular neck 12 extended from a bottom side of the hollow envelope body 11 in such a manner that the space inside the tubular neck 12 is kept in communication with the space inside the hollow envelope body 11, the tubular neck 12 defining an inner peripheral wall 122 for the connection of a LED driver module 2 and an opposing outer peripheral wall 121 for the bonding of a lamp head 3;

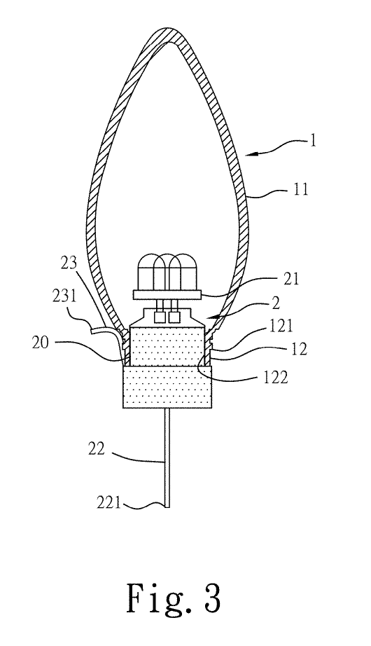

a LED driver module 2 (see FIG. 1) comprising a cladding layer-wrapped circuit board 20 (see FIGS. 2-5) press-fitted into the inner peripheral wall 122 of the tubular neck 12 of the envelope 1 tightly (see FIG. 3 and FIG. 4), a LED circuit assembly 21 electrically connected to the circuit board-wrapped circuit board 20 and extended out of a top side 201 of the circuit board-wrapped circuit board 20 and suspending in the envelope 1 and controllable to emit light, and a positive lead wire 22 and a negative lead wire 23 respectively extended from the cladding layer-wrapped circuit board 20 with one end 221 of the positive lead wire 22 and one end 231 of the negative lead wire 23 disposed outside the envelope 1; and

a lamp head 3 having an inner peripheral wall 31 thereof bonded to the outer peripheral wall 121 of the tubular neck 12 of the envelope 1, a center contact 32 thereof (see FIGS. 3-5) electrically bonded to the positive lead wire 22 of the LED driver module 2, and a top edge of a ring contact 30 thereof (see FIGS. 4 and 5) electrically bonded to the negative lead wire 23 of the LED driver module 2.

Further, the cladding layer of the cladding layer-wrapped circuit board 20 of the LED driver module 2 is preferably selected from foamed plastic materials and molded on the circuit board of the LED driver module 2 by injection molding. Alternatively the cladding layer of the cladding layer-wrapped circuit board 20 of the LED driver module 2 by wrapping dissolving rubber on the circuit board and enabling the wrapped dissolving rubber to be hardened into shape.

In general, the LED lamp bulb of the present invention has the advantages and effects as follows:

1. The LED driver module 2 is fixedly connected to the envelope 1 in a watertight manner by press-fitting the cladding layer-wrapped circuit board 20 into the inner peripheral wall 122 of the tubular neck 12 of the envelope 1 tightly, achieving a waterproof sealing effect.

2. Because the LED driver module 2 is fixedly connected to the envelope 1 in a watertight manner by press-fitting the cladding layer-wrapped circuit board 20 into the inner peripheral wall 122 of the tubular neck 12 of the envelope 1 tightly, the positive lead wire 22 and negative lead wire 23 of the LED driver module 2 can be bonded to the ring contact 30 and center contact 32 of the lamp head 3 and checked automatically using a conventional incandescent lamp bulb lead wire bonding technique.

3. Assembling the LED lamp bulb can be done using an automatic assembly system, saving much labor and time, increasing productivity and significantly reducing the manufacturing cost.

What is claimed is:

1. A LED lamp bulb, comprising:
an envelope comprising a hollow envelope body and a tubular neck extended from a bottom side of said hollow envelope body in such a manner that the space inside said tubular neck is kept in communication with the space inside said hollow envelope body, said tubular neck defining an inner perimeter and an opposing outer perimeter;
a LED driver module comprising a LED circuit assembly suspending in said envelope and controllable to emit light and a positive lead wire and a negative lead wire extended from said LED driver module and disposed outside said envelope;
a lamp head bonded to said outer peripheral wall of said tubular neck of said envelope, said lamp head comprising a center contact electrically connected with said positive lead wire of said LED driver module and a ring contact electrically connected with said negative lead wire of said LED driver module;
wherein:
said LED driver module further comprises a cladding layer-wrapped circuit board press-fitted into said inner peripheral wall of said tubular neck of said envelope in a watertight manner to support said LED circuit assembly in said envelope; said positive lead wire and said negative lead wire of said LED driver module are respectively electrically connected to said cladding layer-wrapped circuit board outside said envelope.

2. The LED lamp bulb as claimed in claim 1, wherein said cladding layer-wrapped circuit board of said LED driver module is selectively wrapped by a foamed plastic material using an injection molding, or wrapped by a dissolving rubber that is hardened into shape.
